(19) United States
(12) Patent Application Publication
(10) Pub. No.: US 2007/0125213 A1
(43) Pub. Date: Jun. 7, 2007

(54) Crowder assembly

(76) Inventor: Steven M. Moilanen, Fort Wayne, IN (US)

Correspondence Address: BARNES & THORNBURG LLP, 600 ONE SUMMIT SQUARE, FORT WAYNE, IN, 46802, US

(21) Appl. No.: 11/633,166

(22) Filed: Dec. 4, 2006

Related U.S. Application Data
(60) Provisional application No. 60/742,464, filed on Dec. 5, 2005.

(51) Int. Cl. B26D 7/06; B23Q 5/22

(52) U.S. Cl. 83/418; 414/19; 72/420

(57) ABSTRACT

A crowder assembly having a rod, a housing, a push pad, and a rod coupler is provided. The rod is reciprocally movable and the housing is movable with the rod. The push pad is movable with the housing and the rod, and is configured to engage and move a workpiece. The rod coupler is located in a bore disposed in the housing and is coupled to the rod. Both the rod coupler and bore have a diameter, wherein the diameter of the bore is greater than the diameter of the rod coupler defining a radial clearance for the rod coupler.

### RELATED APPLICATIONS

The present application is a related to and claims priority to U.S. Provisional Patent Application Ser. No. 60/742,464, filed on Dec. 5, 2005, entitled Crowder Assembly. To the extent not included below, the subject matter disclosed in the provisional application is hereby expressly incorporated into the present application.

### TECHNICAL FIELD

The present disclosure is related to crowder assemblies configured to move a workpiece.

### BACKGROUND AND SUMMARY

A crowder assembly of the type disclosed herein can be used for, but is not limited to, the sheet metal handling industry. Such a crowder assembly may assist in positioning or “crowding” a workpiece or metal sheet to a particular location prior to a stamping or other manufacturing process. Such crowder assemblies can be subjected to impact forces that are created when the crowder engages the workpiece. As a result, it may be possible for that force to transfer into a portion of the actuation mechanism, such as a piston rod, and put stress on the same which might increase the possibility of failure.

Therefore, one illustrative embodiment of the present disclosure provides a crowder assembly comprising a rod, a housing, a push pad, and a rod coupler. The rod is reciprocally movable. The housing is movable with the rod. The push pad is movable with the housing and the rod, and is configured to engage and move a workpiece. The rod coupler is located in a bore disposed in the housing and coupled to the rod. Both the rod coupler and bore have a diameter, wherein the diameter of the bore is greater than the diameter of the rod coupler defining a radial clearance for the rod coupler.

In the above and other illustrative embodiments, the crowder assembly may further comprise: the rod coupler having a thickness and the bore having a thickness greater than the thickness of the rod coupler defining a thrust clearance for the rod coupler; the rod being coupled to an actuator assembly that reciprocally moves the rod; at least one guide shaft coupled to the housing; a body that receives at least a portion of the guide shaft and rod, and houses an actuator assembly that moves the rod; the actuator assembly including a fluid-driven piston coupled to the rod; the push pad comprising a cart that has at least one bearing disposed on a track that limits the movement of the push pad; the track being a cam slot; the cam slot moving the push pad in at least two directions; a link coupled to the housing and to the cart to move the cart along the cam slot; and the radial and thrust clearances at least reduce the force transferred into the rod created upon impact between the push pad and the workpiece.

Another illustrative embodiment of the present disclosure provides a crowder assembly comprising a body, an actuator, housing and a push pad. The actuator assembly is located in the body and comprises a fluid-driven piston coupled to a rod extending therefrom. At least a portion of the piston rod is located exterior of the body. The housing receives a portion of the rod distal from the piston and is movable with the rod. A space is provided between an interior surface of the housing and the rod which allows the housing to be movable with respect to the rod. And a push pad is provided that is movable with the housing to engage a workpiece.

In the above and other illustrative embodiments, the crowder assembly may further comprise: at least one guide shaft coupled to the housing, disposed in the body, and movable with the rod; the push pad comprising a cart that has at least one bearing disposed on a track that limits the movement of the push pad; the track being a cam slot; the cam slot allowing movement of the push pad in at least two directions; a link being coupled to the housing and to the cart so that movement of the housing moves the cart along the cam path; and the space provided between the interior surface of the housing and the rod forms first and second spaces allowing the housing to be movable with respect to the rod in a plurality of directions.

Additional features and advantages of the crowder assembly will become apparent to those skilled in the art upon consideration of the following detailed description of the illustrated embodiment exemplifying the best mode of carrying out the crowder assembly as presently perceived.

### BRIEF DESCRIPTION OF THE DRAWINGS

The present disclosure will be described hereafter with reference to the attached drawings which are given as non-limiting examples only, in which:

FIGS. 1a and b are perspective front and rear views of an illustrative embodiment of a crowder assembly;

FIGS. 2a-c are side progression views of an illustrative crowder assembly demonstrating how it engages and moves a workpiece;

FIG. 3 is an exploded view of the illustrative crowder assembly of FIGS. 1 and 2;

FIGS. 4a-c are top, side cross-sectional, and detail views, respectively, of the crowder assembly;

FIGS. 5a-c are additional top, side cross-sectional, and detail views of the crowder assembly;

FIG. 6 is an exploded view of a portion of the crowder assembly including guide shafts, housing, cylinder coupler and thrust washers; and

FIG. 7 is an exploded view of another portion of the crowder assembly including the cart assembly and link.

Corresponding reference characters indicate corresponding parts throughout the several views. The exemplification set out herein illustrates embodiments of the crowder assembly, and such exemplification is not to be construed as limiting the scope of the crowder assembly in any manner.

### DETAILED DESCRIPTION OF THE DRAWINGS

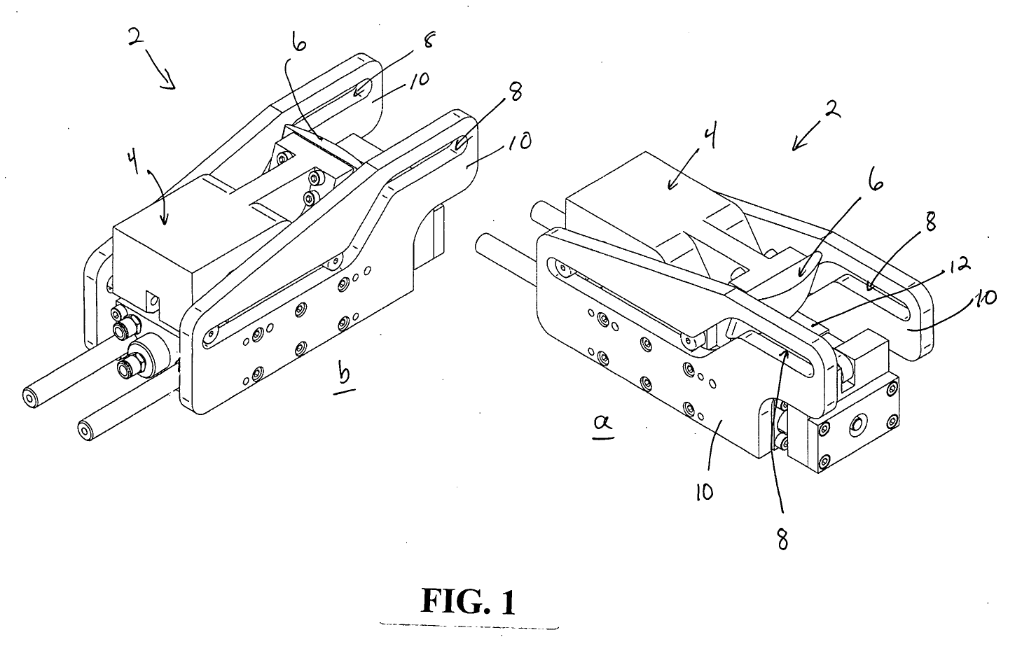

Front and rear perspective views of crowder assembly 2 are shown in FIGS. 1a and b, respectively. An illustrative embodiment of assembly 2 includes a cart assembly 4 having a push pad 6 attached thereto. Cart assembly 4 moves along a path dictated by cam slot 8 of brackets 10 to move sheet metal or other workpiece to a desired location. In this illustrative embodiment, cart assembly 4, when at rest, is positioned adjacent body 12 of assembly 2. The illustrative path of travel of cart assembly 4 is such that as it moves forward along slot 8 it causes push pad 6 to also move upward from body 12 to engage a workpiece. The push pad 6 can then be retracted via movement along cam slot 8 to return cart 4 to its starting position.

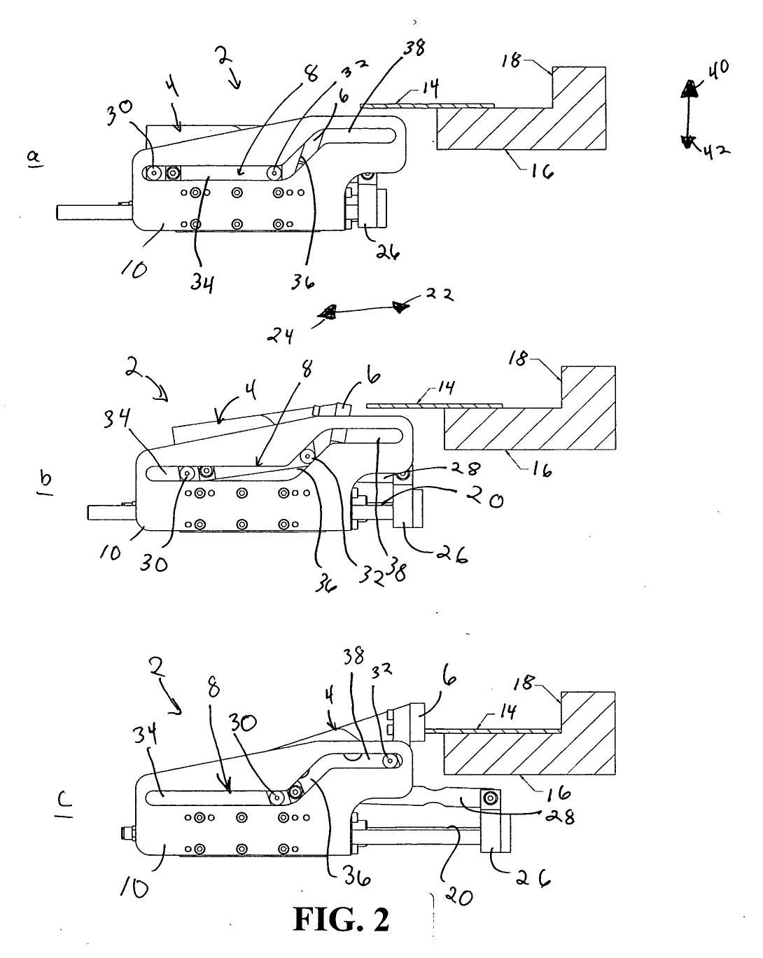

Side progression views of crowder assembly 2 demonstrating its ability to move sheet metal or a workpiece 14 are shown in FIGS. 2a-c. As shown in FIG. 2a, cart assembly 4 is located in its fully retracted position and workpiece 14 is illustratively located on a panel support 16. It can be appreciated from this view that cart assembly 4 being retracted allows workpiece 14 to be moved overtop crowder 2. Workpiece 14 is slid or otherwise moved from some other location to that shown in FIG. 2a. Crowder assembly 2 is then activated to move workpiece 14 against panel stop 18. As shown in FIG. 2b, crowder assembly 2 is activated by an actuator, typically a pneumatic-driven piston assembly configured to move rod 20 reciprocally in directions 22 and 24. It is contemplated that in alternative embodiments, the actuator may be electrical or hydraulic. In this view, rod 20 is moved a distance in direction 22 which pushes a tool plate or housing 26 in direction 22 as well. A link 28 is coupled to both housing 26 and cart assembly 4. This causes link 28 to move cart assembly 4 also in direction 22. Cam followers or bearings 30 and 32 of cart assembly 4 are located in cam slot 8. The illustrative contour of cam slot 8 includes a lower plateau section 34, a rise section 36, and an upper plateau section 38. As first seen in FIG. 2a, when the bearings 30 and 32 are both located in lower plateau section 34, cart assembly 4 is also located in its lowered position. As FIG. 2b demonstrates, when cart assembly 4 is moved in direction 22, bearing 32 moves to rise section 36 of slot 8 also driving cart assembly 4 upward in direction 40. As shown in FIG. 2c, rod 20 moving further in direction 22 causes bearing 32 to move into upper plateau section 38 and causes pad 6 on cart assembly 4 to engage and move workpiece 14 in direction 22. As this illustrative embodiment shows, workpiece 14 is moved in direction 22 until it abuts panel stop 18 which is the desired stopping point for the workpiece 14 in this example. It can be appreciated from this view that when pad 6 engages workpiece 14, forces can be exerted on crowder assembly 2 including impact forces. It is also contemplated that pad 6 can be extended as shown in FIG. 2c and be impacted by a moving workpiece 14. Crowder assembly 2 may be used as an abutment to selectively stop a moving workpiece 14 at a desired location. In this instance the impact forces against pad 6 may be even more pronounced.

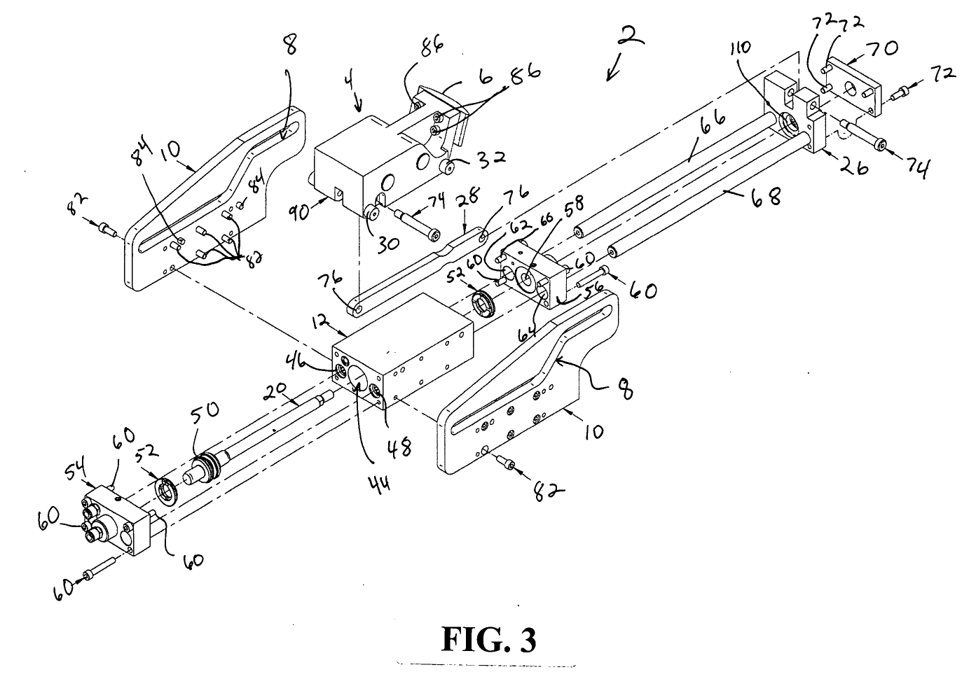

An exploded view of crowder assembly 2 is shown in FIG. 3. This illustrative embodiment includes body 12 with bores 44, 46, and 48 disposed therethrough. A piston 50 illustratively attached to rod 20 is disposed in bore 44. Seals 52 maintain pressure within bore 44 forming a seal between the same and caps 54 and 56. In this embodiment, rod 20 extends through bore 58 and cap 56 so that a portion is located exterior of body 12. In a further illustrative embodiment, caps 54 and 56 are attached to body 12 via fasteners 60. Bores 62 and 64 are also disposed through cap 56 and are illustratively co-axially aligned with bores 46 and 48, respectively, and are configured to receive guide shafts 66 and 68, respectively. In one illustrative embodiment, housing 26 is attached to guide shaft 66 and 68. A backing plate 70 is attached to housing 26 illustratively via fasteners 72. Link 28 is coupled to both housing 26 and cart assembly 4 illustratively via fasteners 74 disposed through bores 76 of link 28. It can be appreciated that in this illustrative embodiment, link 28 can pivot with respect to cart assembly 4 and housing 26. Brackets 10 are fastenable to body 12 via fasteners 82. Also shown are dowels 84 which may assist in proper placement of plates 10 onto body 12. Cam slots 8 on each of the brackets receive bearings 30 and 32 shown being part of assembly 4. Pad 6 of cart assembly 4 is shown illustratively attached via fasteners 86.

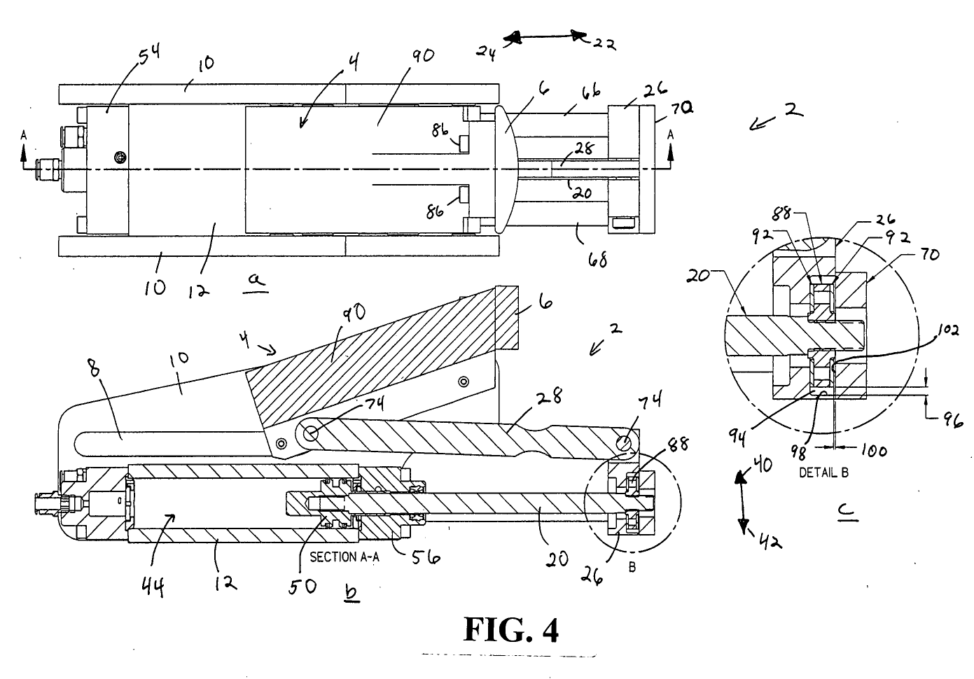

Top, side cross-sectional, and detail views of assembly 2 are shown in FIGS. 4a, b, and c, respectively. These views show rod 20 and cart assembly 4 fully extended. The view in FIG. 4a depicts cart assembly 4 moved in direction 22 that moved pad 6 to a location where it can engage a workpiece. In this illustrative embodiment, housing 26, along with guide shafts 66 and 68, and link 28 also travel outward in direction 22. The view shown in FIG. 4b shows the connection between link 28 and cart assembly 4. In this illustrative embodiment, fluid such as air is supplied to bore 44 in body 12 to power piston 50 moving the same, in this case, in direction 22. Rod 20 moves in direction 22 extending a portion of same out of body 12 and cap 56. With rod 20, via cylinder coupler, coupled to housing 26, link 28 is drawn in direction 22 as well. Link 28 being attached to cart 90 of assembly 4 pulls the same along the pathway formed by cam slot 8 moving cart assembly 4 as illustratively depicted herein.

Because it is contemplated that pad 6 will engage a piece of sheet metal or workpiece (see FIGS. 2a-c), it may be expected that significant forces, including impact forces, may be applied to assembly 2 during its normal use. It might also be possible that under normal circumstances such a force or forces could be distributed to several components of assembly 2. The impact force may be from either pad 6 impacting the workpiece (e.g., the views of FIGS. 2a-c) or the workpiece impacting pad 6. In the latter instance, a piece of sheet metal or workpiece 14 can slide, possibly rapidly, on a conveyor belt and impact extended pad 6 creating substantial impact force on the same. Such forces may deleteriously affect rod 20, since it along with piston 50 drives other structures of assembly 2. If these driving structures were damaged, it might reduce the life of assembly 2 and/or require premature maintenance translating into additional cost. This being the case, it could be useful to provide a mechanism that may reduce the amount of force or forces transferring from pad 6 to rod 20. As shown in FIG. 4c, rod 20 includes cylinder coupler 88 and thrust washers 92 that are located in a cavity 94 within housing 26 and illustratively backing plate 70. In this case, cavity 94 is formed slightly larger than cylinder coupler 88/thrust washers 92 to allow a clearance. For example, a radial clearance 96 is a spacing provided between coupler 88/thrust washers 92 and surface 98 of cavity 94. This clearance allows movement of rod 20 in directions 40 and 42 within cavity 98 (about 0.133 inch radial clearance, for example). Similarly, a thrust clearance 100 is another spacing provided between cylinder coupler 88/thrust washers 92 and surface 102 of cavity 94. This also allows movement between housing 26 and rod 20 (about 0.024 inch thrust clearance, for example). The result is that rod 20 may “float” within housing 26. It is, therefore, possible that an impact or other force exerted on pad 6 that transfers through cart 90, link 28, and housing 26, may not necessarily all transfer into rod 20, because there is no rigid attachment between it and housing 26. The force can dissipate in housing 26 without it substantially transferring into rod 20.

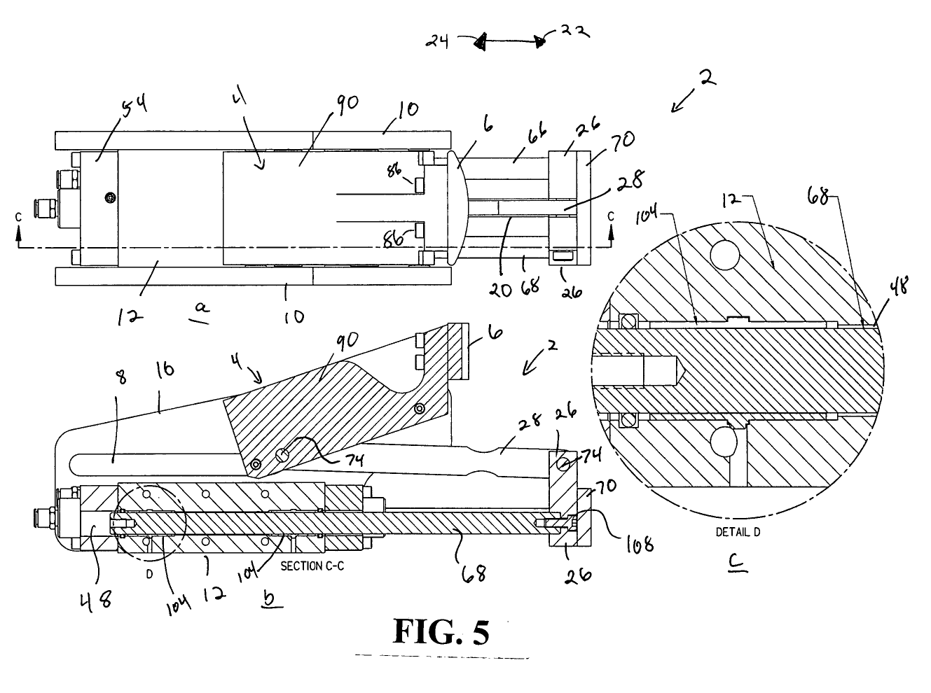

Top, side cross-sectional, and detail views of assembly 2 are shown in FIGS. 5a-c. Crowder assembly 2 in these views is in the same position as that shown in FIGS. 4a-c. Here, however, the cross-section is taken along lines c-c of FIG. 5a through guide shaft 68. In this illustrative embodiment, two guide shaft bearings are disposed through body 12. It is appreciated that in alternative embodiments, other bearing configurations may be used including a single bearing structure. Illustratively, guide shafts 66 and 68 may also be load bearing. In other words, the shafts may receive some portion of the external force(s) acting on crowder assembly 2 that may otherwise transfer to other structures within the assembly. (See FIG. 5b.) As shown in FIG. 5c, guide shaft 68 is disposed through bore 48 which includes a guide shaft bearing 104. It is appreciated that bearing 104 assists in providing smooth reciprocal movement of guide shaft 68. It is further appreciated, as shown in FIG. 5b, that a plurality of guide shaft bearings 104 can be used throughout bore 48. Guide shaft 68 is attached to housing 26 via fastener 108. It is even further appreciated that the structures, as discussed with respect to guide shaft 68, also apply to guide shaft 66.

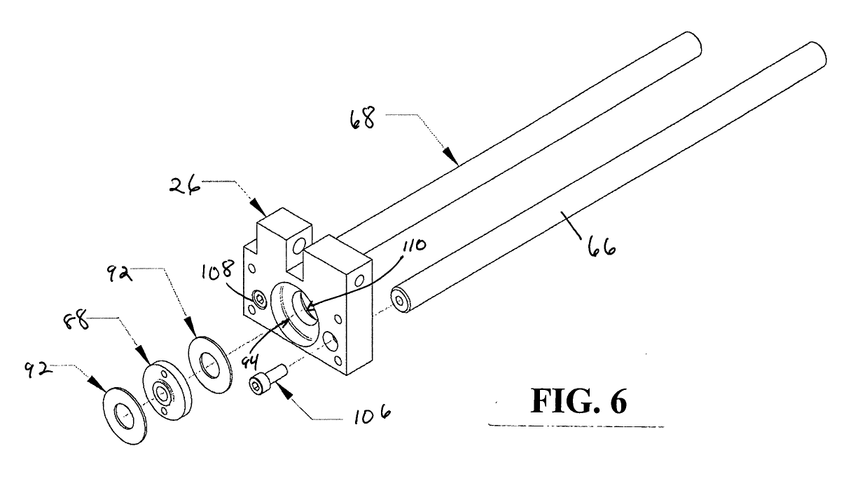

An exploded view of housing 26 with guide shafts 66 and 68, cylinder coupler 88, thrust washers 92, and fasteners 106 and 108 are shown in FIG. 6. This view shows how guide shafts 66 and 68 are fastened to housing 26 via fasteners 106 and 108, respectively. Also, thrust washers 92 may abut cylinder coupler 88 with all being located in cavity 94 which receives rod 20 through opening 110.

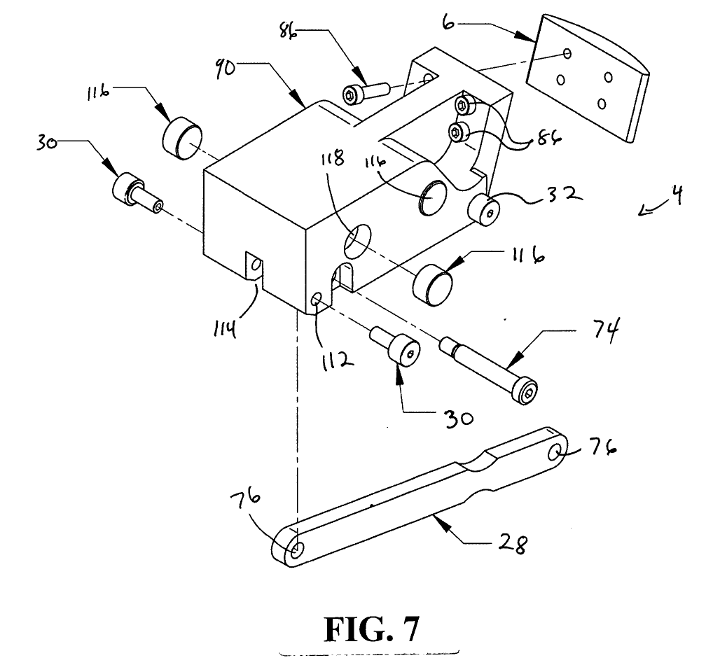

An exploded view of illustrative cart assembly 4 is shown in FIG. 7. Bearings 30 and 32 are illustratively mounted into threaded bores 112 of cart 90. Push pad 6 is attached to the end of cart 90 via fasteners 86. A slot 114 is disposed along the lower periphery of cart 90 and configured to receive link 28 and attach to it via fastener 74. In an illustrative embodiment, bore 76 that receives fastener 74 allows link 28 to rotate thereabout. In another illustrative embodiment, thrust bearings 116 can be installed in openings 118 of cart 90 which may reduce wear on the cart as it travels between brackets 10.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed is:

1. A crowder assembly comprising:
a rod that is reciprocally movable;
a housing that is movable with the rod;
a push pad that is movable with the housing and the rod;
wherein the push pad is configured to engage and move a workpiece; and
a rod coupler located in a bore disposed in the housing and coupled to the rod;
wherein the rod coupler has a diameter and the bore has a diameter that is greater than the diameter of the rod coupler defining a radial clearance for the rod coupler.

2. The crowder assembly of claim 1, wherein the rod coupler has a thickness and the bore has a thickness which is greater than the thickness of the rod coupler defining a thrust clearance for the rod coupler.

3. The crowder assembly of claim 1, wherein the rod is coupled to an actuator assembly that reciprocally moves the rod.

4. The crowder assembly of claim 1, wherein at least one guide shaft is coupled to the housing.

5. The crowder assembly of claim 4, further comprising a body that receives at least a portion of the guide shaft and rod, and houses an actuator assembly that moves the rod.

6. The crowder assembly of claim 5, wherein the actuator assembly includes a fluid-driven piston coupled to the rod.

7. The crowder assembly of claim 1, wherein the push pad comprises a cart that has at least one bearing that is disposed on a track that limits the movement of the push pad.

8. The crowder assembly of claim 7, wherein the track is a cam slot.

9. The crowder assembly of claim 8, wherein the cam slot allows movement of the push pad in at least two directions.

10. The crowder assembly of claim 9, further comprising a link that is coupled to the housing and to the cart to move the cart along the cam slot.

11. The crowder assembly of claim 2, wherein the radial and thrust clearances at least reduce the force transferred into the rod created upon impact between the push pad and the workpiece.

12. A crowder assembly comprising:
a body;
an actuator assembly located in the body;
wherein the actuator assembly comprises a fluid-driven piston coupled to a rod extending from the body;
wherein at least a portion of the rod is located exterior of the body;
a housing that receives a portion of the rod distal from the piston and is movable with the rod;
wherein a space is provided between an interior surface of the housing and the rod which allows the housing to be movable with respect to the rod; and
a push pad that is movable with the housing to engage a workpiece.

13. The crowder assembly of claim 12, wherein at least one guide shaft is coupled to the housing, disposed in the body, and movable with the rod.

14. The crowder assembly of claim 12, wherein the push pad comprises a cart that has at least one bearing that is disposed on a track that limits the movement of the push pad.

15. The crowder assembly of claim 14, wherein the track is a cam slot.

16. The crowder assembly of claim 15, wherein the cam slot allows movement of the push pad in at least two directions.

17. The crowder assembly of claim 16, further comprising a link that is coupled to the housing and to the cart so that movement of the housing moves the cart along the cam path.

18. The crowder assembly of claim 17, wherein the space provided between an interior surface of the housing and the rod, forms first and second spaces allowing the housing to be movable with respect to the rod.
